(19) United States
(12) Patent Application Publication
(10) Pub. No.: US 2008/0120101 A1
(43) Pub. Date: May 22, 2008

(54) CONFERENCE QUESTION AND ANSWER MANAGEMENT

(75) Inventors: Andrew Johnson, Charlotte, NC (US); Luc Antoine Bouchard, Kanata (CA)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(73) Assignee: CISCO TECHNOLOGY, INC., San Jose, CA (US)

(21) Appl. No.: 11/560,563

(22) Filed: Nov. 16, 2006

(51) Int. Cl. H04M 3/56; G10L 15/26

(52) U.S. Cl. 704/235; 379/202.01; 704/E15.043

(57) ABSTRACT

In one embodiment, an apparatus includes an interface and a queue generator. The interface obtains a plurality of submissions associated with a conference call. The submissions include at least one text-based submission and at least one audio-based submission. The queue generator manages a queue that has representations of at least some of the submissions, and is accessible to a speaker associated with the conference call. The representations include a first representation of the text-based submission and a second representation of the audio-based submission.

### FIELD OF INVENTION

The present invention relates generally to conferencing systems.

### BACKGROUND OF THE INVENTION

During conference call meetings, particularly those involving a single speaker and attendees who do not speak during the course of a speaker's presentation, attendees generally withhold any questions they may have until the speaker has completed his or her presentation. Questions that the attendees may have are asked by the attendees at the completion of the presentation, e.g., during a question and answer session, when the attendees are given control of the conference room floor. Speakers, as well as moderators, field questions, but it is often difficult for questions to be fielded and answered efficiently. By way of example, duplicate questions may be asked, and a deluge of questions may be difficult to manage.

### BRIEF DESCRIPTION OF THE DRAWINGS

The invention may best be understood by reference to the following description taken in conjunction with the accompanying drawings in which:

FIG. 1A illustrates an example system with a moderator or engine that is arranged to create a ranked submissions queue.

FIG. 1B illustrates an example of a moderator or engine that generates a ranked submissions queue that includes both audio and text submissions.

FIG. 2 illustrates an example of interactions associated with a moderator or engine that processes audio and text questions, and has transcript generation capabilities.

FIG. 3 illustrates an example method of processing questions using an engine.

FIG. 4 illustrates an example method of ranking a question relative to questions in a ranked questions queue.

FIG. 5 illustrates an example method of utilizing a ranked questions queue.

### DESCRIPTION OF EXAMPLE EMBODIMENTS

### Overview

In one embodiment, an apparatus includes an interface and a queue generator. The interface obtains a plurality of submissions associated with a conference call. The submissions include at least one text-based submission and at least one audio-based submission. The queue generator manages a queue that has representations of at least some of the submissions, and is accessible to a speaker associated with the conference call. The representations include a first representation of the text-based submission and a second representation of the audio-based submission.

### Description

Within a conference call management system, using a substantially single queue to organize questions that have been asked allows questions to be answered in an efficient manner. During a conference call in which there is a floor control feature, a speaker gives a presentation to multiple silent attendees or participants. Examples of a conference call in which there may be floor control capabilities include, but are not limited to, electronic learning meetings and all-hands meeting. There is often a question and answer session towards the end of a conference call. A single queue that organizes substantially all audio and text questions that are posed may effectively eliminate “free-for-all” question and answer sessions in which the same question may be asked by multiple people, as instances of approximately the same question may be addressed as a single question. A single queue, when arranged to prioritize questions, allows a logical process flow for fielding questions and enables more important questions to be answered earlier in the question and answer session, e.g., when more attendees are likely to still be connected with the conference call.

In one embodiment, a moderator or an engine collects audio and/or text questions, and ranks the questions before populating a single queue, e.g., “a ranked submissions queue” or a “ranked questions queue,” with textual versions of the questions. Ranking the questions allows potentially more relevant questions to be prioritized over potentially less relevant questions such that a moderator or a speaker may address the more relevant questions first. That is, questions that are perceived as being more important may be addressed first. The moderator may be a human who feeds the speaker questions that are posed by attendees in a prioritized order such that the questions with the highest priority are addressed first. The moderator and/or the speaker may also use the ranked questions queue to visually identify potentially antagonistic questions and subsequently frame them in a more positive light before the speaker addresses the questions.

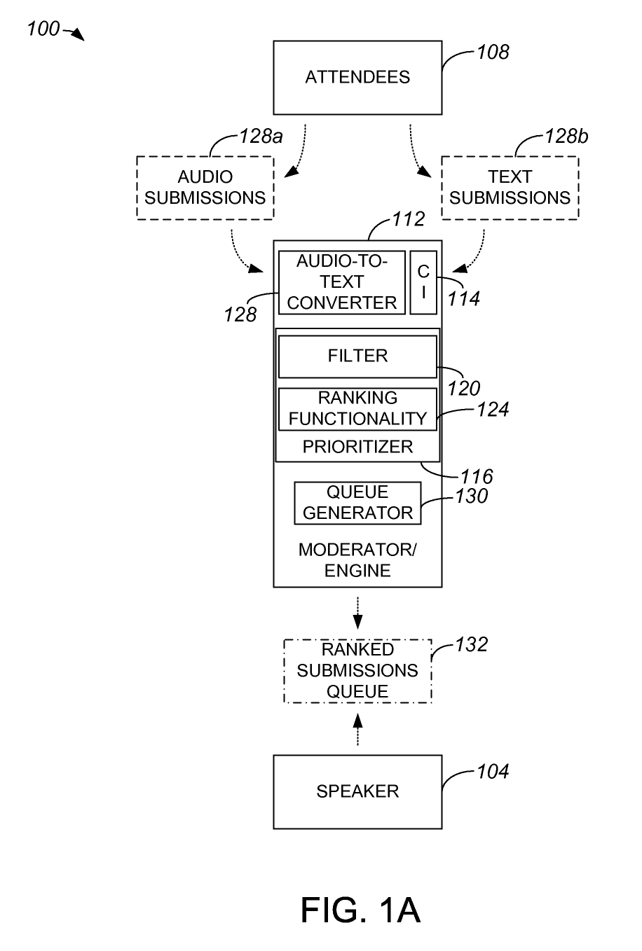

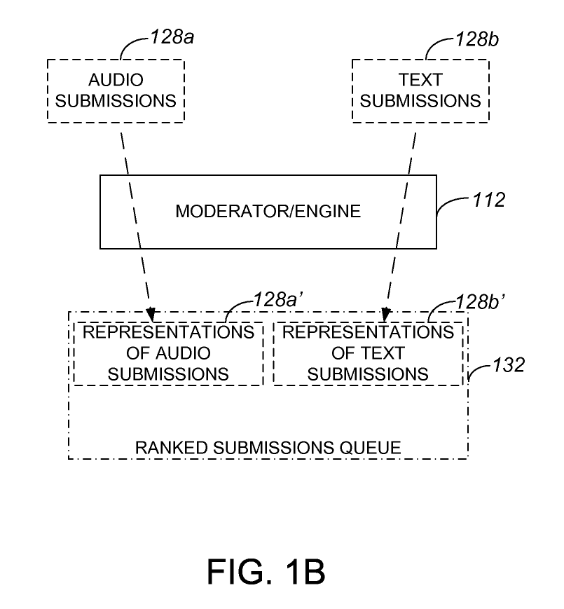

Referring initially to FIG. 1, a conference call system that utilizes a queue in which submissions are collected will be described. A conference call system 100, which may be implemented within a network environment, includes a speaker 104 and attendees 108. Conference call system 100 may be an audio conferencing system or a video conferencing system. Speaker 104 may generally be a presenter at a meeting that is attended, typically virtually, by attendees 108. When attendees 108 call into or otherwise access a conference call that speaker 104 is to present or otherwise speak at, attendees may access a conference bridge (not shown) through telephones, e.g., voice over Internet Protocol (VoIP) telephones, or through computer systems that have access to the conference bridge.

Attendees 108 may formulate submissions 128a, 128b that are intended to be addressed by speaker 104. Submissions 128a, 128b are generally formulated during a question and answer session towards the end of a conference call, although it should be appreciated that submissions 128a, 128b may also be submitted prior to the question and answer session. Submissions 128a, 128b include audio submissions 128a that are verbalized and text submissions 128b that are text-based. Audio submissions 128a may be made by attendees 108 by entering keystrokes onto a computer keyboard or telephone keypad that indicate that an audio submission is forthcoming, and then speaking into a microphone associated with a computer or a telephone. Text submissions 128b may be created by attendees 108 and then sent, e.g., via electronic mail or chat sessions to a moderator or an engine 112.

Submissions 128a, 128b may be received, recorded, or captured by a collection interface 114 of moderator/engine 112. It should be appreciated that moderator/engine 112 may be included in a conference bridge (not shown), or moderator/engine 112 may be in communication with the conference bridge. If moderator/engine 112 is an engine, the engine may include processors and memory that are arranged to cooperate to execute logic that implements functionality associated with the engine. The logic may include either or both software logic and hardware logic. Moderator/engine 112 includes an audio-to-text converter 128 that converts audio submissions 128a into textual versions of audio submissions 128a. In one embodiment, audio-to-text converter 128 may be a speech-recognition engine or application.) Once submissions 128a, 128b are captured by collection interface 114, submissions 128a, 128b are processed by a prioritizer 116. Prioritizer 116 is arranged to substantially assign priorities to submissions 128a, 128b.

Prioritizer 116 includes a filter 120 and ranking functionality 124. Filter 120 allows potentially inappropriate submissions to be prevented from being ranked by ranking functionality 124, which generally ranks submissions 128a, 128b, as for example in a relational manner. A queue generator 130 manages, e.g., creates and maintains, a queue 132 that effectively includes text submissions 128b and textual versions of audio submissions 128a. Queue 132 may be a ranked submissions queue in that text submissions 128b and textual versions of audio submissions 128a may be ordered within queue 132 based on priority. It should be appreciated that in addition to providing a ranked or prioritized accounting of submissions 128a, 128b, queue 132 may also include indications of a chronological order in which submissions 128a, 128b were received.

When speaker 104 is ready to address submissions 128a, 128b, speaker 104 may access queue 132 to effectively select submissions 128a, 128b. As submissions 128a, 128b are prioritized, speaker 104 may elect to address submissions 128a, 128b in order of assigned priority. However, if speaker 104 is also provided with an indication of an order in which submissions 128a, 128b were received, speaker 104 may decide to address submissions 128a, 128b in the order in which submissions 128a, 128b were received.

FIG. 1B illustrates moderator/engine 112 generating ranked submissions queue 132. When audio submissions 128a and text submissions 128b are provided to moderator engine 112, moderator/engine 112 creates ranked submissions queue 132 to effectively include audio submissions 128a and text submissions 128b. In the described embodiment, moderator/engine 112 creates representations 128a′ of audio submissions 128a and stores representations 128a′ in ranked submissions queue 132. Similarly, moderator/engine 112 creates representations 128b′ of text submissions 128b and stores representations 128b′ in ranked submissions queue 132. Representations 128a′ may be textual versions of audio submissions 128a, while representations 128b′ may be substantially unaltered versions of text submissions 128b.

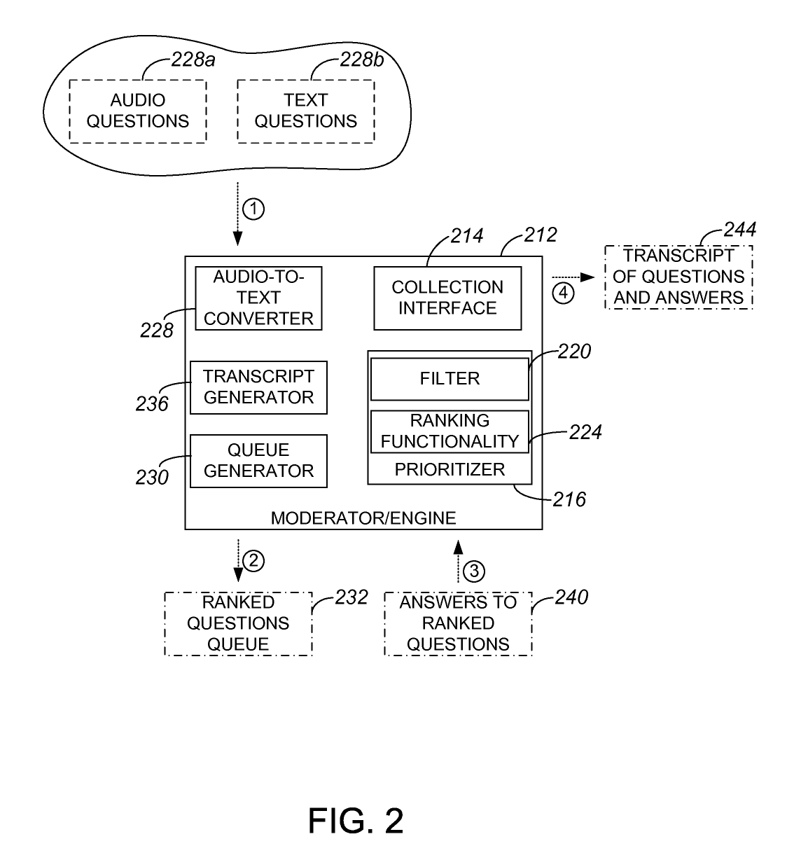

Submissions intended for a speaker or presenter of a conference call may include questions to which answers from the speaker are desired. FIG. 2 illustrates an example of interactions associated with a moderator/engine that processes audio and text questions. A moderator/engine 212 may collect audio questions 228a and text questions 228b using a collection interface 214. Audio questions 228a may be collected, in one embodiment, when a participant in a conference call requests control of the conference call floor through collection interface 214. Text representations of audio questions 228a may be created by an audio-to-text converter 228. Questions 228a, 228b may be prioritized by a prioritizer 216 that includes a filter 220 and ranking functionality 224. A ranked questions queue 232 may be generated by queue generator 230 to effectively include questions 228a, 228b in a prioritized order.

Once a speaker (not shown) answers questions 228a, 228b associated with ranked questions queue 232, answers 240 may be provided to moderator/engine 212 via collection interface 214. Answers 240 may be text based, although answers 240 are typically audio based. If answers 240 are audio based, answers 240 may be processed by audio-to-text converter 228.

In one embodiment, a transcript of a question and answer session may be desired by attendees of a conference call. Hence, after answers 240 are converted into text representations by audio-to-text converter 228, a transcript generator 236 may create a transcript 244 that includes questions 228a, 228b and answers 240. Moderator/engine 212 may distribute transcript 244 to attendees of the conference call.

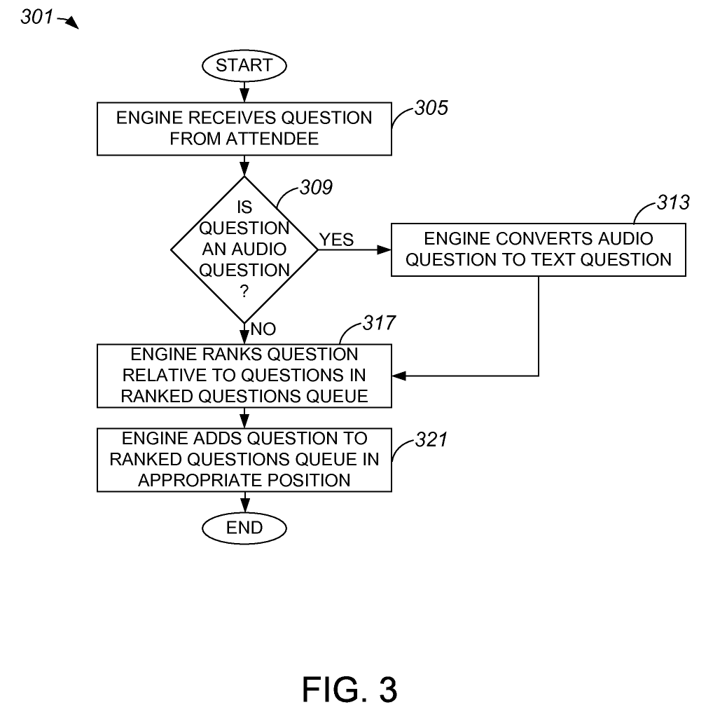

Either a moderator, e.g., a human moderator, or an engine may generally be arranged to convert audio submissions into text, to filter in appropriate submissions, to prioritize or otherwise rank submissions, and to generate a ranked submissions queue. A human moderator may generally utilize a computing system to generate a ranked submissions queue. In one embodiment, submissions are questions that are processed using an engine, as will be discussed with respect to FIG. 3. A method 301 of processing a question begins at step 305 in which the engine receives the question from an attendee. The question may be an audio question that is recorded by the attendee, or the question may be a text question that the attendee entered into a computing system and forwarded to the engine, e.g., through the use of a chat room associated with the conference call. The question may be received when the attendee initiates a floor-control request, or as a part of a floor-request in general.

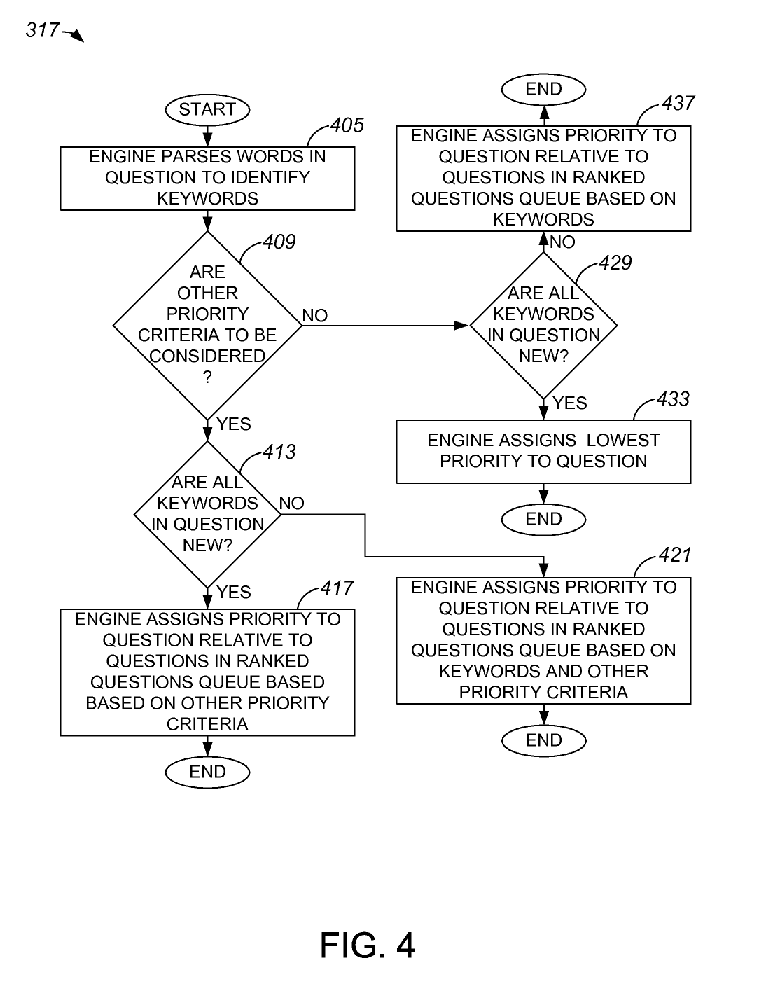

It is determined in step 309 whether the question is an audio question. If it is determined that the question is not an audio question, then the question is typically a text questions. As such, in step 317, the engine ranks the question relative to other questions in a ranked questions queue. One method of ranking the question will be described below with respect to FIG. 4. Once the question is ranked, the engine adds the question to the ranked questions queue in an appropriate position, e.g., in a position consistent with the rank or priority assigned to the question in step 321. It should be appreciated that adding the question to the ranked questions queue may include adjusting the ranking of a version of the question that was previously in the ranked questions queue, rather than actually adding the question to the ranked questions queue. After the question is added to the ranked questions queue, the processing of a question is completed.

Returning to step 300, if it is determined that the question is an audio question, the audio question is typically converted into a textual form before being added to a ranked questions queue. Accordingly, in step 313, the engine converts the audio question to a text question, and process flow proceeds to step 317 in which the engine ranks the question.

FIG. 4 illustrates a process of ranking a question, e.g., step 317 of FIG. 3, received during a conference call in accordance with an embodiment of the present invention. A process 317 of ranking a question begins at step 405 in which an engine parses words in the question to identify any words that may be considered to be keywords. In other words, the engine identifies words in the question which may be used to rank or otherwise prioritize the question relative to other questions posed during a conference call. It should be appreciated that at least one word in the question is typically considered to be a keyword, and that some words in the question may be considered not to be keywords.

Once at least one keyword is identified, a determination is made in step 409 regarding whether any other priority criteria are to be considered. Such a determination may be made by the engine based upon information provided to the engine, as for example by a system administrator or by a moderator. The priority criteria that may be widely varied, and may include, but are not limited to, particular words or topics which are considered to be important and the sources of questions. For instance, if a question has a keyword that is a match to a topic that is considered to be important, the question may be associated with a higher priority or ranking than a question that does not have a keyword that is a match to the topic. If a source of a question is an attendee whose input is considered to be highly important, the question may be associated with a higher priority or ranking than a question posed by another source.

If the determination in step 409 is that there are no other priority criteria to be considered, the indication is that the question is to be ranked based on the keywords identified in step 405. Accordingly, it is determined in step 429 whether all the keywords in the question are new. In other words, a determination is made in step 429 regarding whether the question is likely a question which has not previously been posed. If all the keywords in the question are new, then the engine assigns the lowest priority to the question in step 433. Assigning the question the lowest priority because the question has not been previously asked allows the question to effectively be moved to the end of a queue of questions. After the question is assigned a priority, the process of ranking the question is completed.

Alternatively, if it is determined in step 429 that not all keywords in the question are new, the indication is that a similar question may have previously been posed. As such, the question may effectively be considered to be an additional occurrence of a previously asked question, and the ranking of the previously asked question may be updated based on the additional occurrence. In one embodiment, both the question and the previously asked question may be assigned a common ranking, and may be provided with indications that identify the two questions as being related. Hence, in step 437, the engine assigns a priority to the question relative to other questions in a ranked question queue. Assigning the priority may, in some instances, include updating the ranking of an existing question that is already in the ranked question queue to indicate that the question is an additional instance of the existing question. Once the engine assigns a relative priority to the question, the process of ranking the question is completed.

Returning to step 409, if the engine determines that at least one criterion is to be considered when determining the priority of the question, process flow moves to step 413 in which it is determined if all keywords in the question are new. If it is determined that all keywords in the question are new, the engine assigns a priority based on the other priority criteria in step 417 to the question relative to questions in a ranked questions queue. As the keywords are new in that the engine has not encountered the keywords during the course of ranking questions that pertain to the conference call associated with the question, the other priority criteria may be used substantially without comparing the keywords to keywords associated with other questions. However, in an embodiment in which the other priority criteria include particular words or topics of interest, the engine may compare keywords to those particular words or topics in the course of assigning a priority to the question. After the engine assigns a priority to the question, the process of ranking the question is completed.

On the other hand, if it is determined in step 413 that all the keywords in the question are not new, then the implication is that the engine has previously ranked at least one other question that included at least one of the keyword. Accordingly, the engine assigns a priority to the question based on the keywords and other priority criteria in step 421, and the process of ranking the question is completed. If a similar question already has an assigned priority, the priority may be updated to account for the question essentially being an additional occurrence of the similar question.

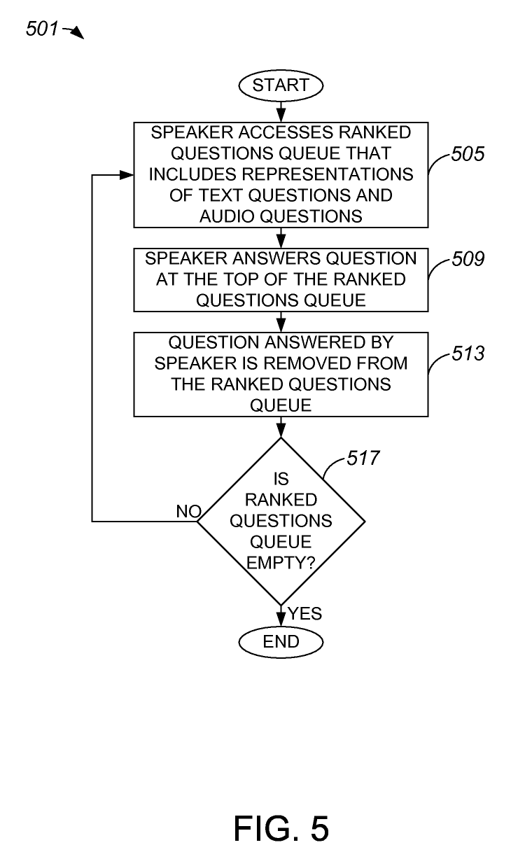

With reference to FIG. 5, one embodiment of a method for utilizing a ranked questions queue will be described. A process 501 of utilizing a ranked questions queue begins at step 505 in which a speaker on a conference call, e.g., at least one speaker who is giving an audio or visual presentation to a group of substantially silent attendees, accesses a ranked questions queue. In one embodiment, the ranked question queue includes textual representations of both audio or orally verbalized questions from the attendees of the conference call and text-based questions from the attendees of the conference call. The speaker may access the ranked questions queue substantially directly, as for example by viewing the ranked questions queue on a display screen of a computing system, or substantially indirectly, as for example through a human moderator who views the ranked questions queue on a display screen and then reads questions to the speaker. It should be appreciated that a conference call may not necessarily include a human moderator.

Once the speaker access the ranked questions queue, the speaker answers the question at the top of the ranked questions queue in step 509. In general, the question at the top of the ranked questions queue is the highest priority question in the ranked questions queue. The speaker may verbalize an answer to the question such that attendees may listen to his or her answer, or the speaker may provide a textual answer to the question. Alternatively, the speaker may provide both a verbal answer and a textual answer to the question.

After the question is answered by the speaker, the question is removed in step 513 from the ranked questions queue, e.g., the question is popped from the ranked questions queue. The speaker may remove the question, or a human moderator who has access to the ranked questions queue may remove the question.

In step 517, it is determined if the ranked questions queue is empty. That is, a determination is made regarding whether there are additional questions to be answered. If it is determined that the ranked questions queue is not empty, process flow returns to step 505 in which the speaker accesses the ranked questions queue. Alternatively, if it is determined that the ranked questions queue is empty, the process of utilizing the ranked questions queue is completed.

Although only a few embodiments of the present invention have been described, it should be understood that the present invention may be embodied in many other specific forms without departing from the spirit or the scope of the present invention. By way of example, if a new question is similar to a previously ranked question in that the questions share common keywords or at least have keywords that are substantially synonymous, the new question may be added to a ranked questions queue, and both the new question and the previously ranked question may be assigned the same priority and identified as being substantially the same question. Alternatively, the new question may be considered to be substantially equivalent to the previously ranked question, in which case the new question may not necessarily be added to the ranked questions queue. In such a case, the ranking of the previously ranked question may be adjusted to indicate that the new question is effectively the same as the previously ranked question, and the previously ranked question may have an associated counter that essentially indicates how many times a question that is the same as or is equivalent to the previously ranked question has been asked.

If a new question has multiple keywords, and if substantially all of the multiple keywords match keywords of an already-ranked question, the new question may be considered to be an additional instance or occurrence of the already-ranked question. However, if fewer than all of the multiple keywords in the new question match keywords in the already-ranked question, while the new question may be considered to be an instance of the already-ranked question, the new question may instead be considered to be a separate question and ranked accordingly. In other words, an engine may be configured to determine that a new question is a match of an already-ranked question if fewer than all keywords in the new question match keywords of the already-ranked question. Alternatively, the engine may be configured to determine that such a new question is a separate question from the already-ranked question. Algorithms executed by the engine to make such determinations may vary widely.

While a ranked questions queue has been described as being text based, e.g., a ranked questions queue may include textual representations of both audio-based and text-based questions, a ranked questions queue may instead be audio based. In one embodiment, text questions may be converted to audio questions, and may be stored in an audio-based ranked questions queue along with other audio questions.

Any number of types of questions may generally be represented in a ranked questions queue. In other words, questions are not limited to including audio questions and text questions. For instance, questions may also include video questions, or questions posed via a video interface, without departing from the spirit or the scope of the present invention. It should be appreciated that as questions posed via a video interface may include an audio component, such questions may be processed as audio questions.

In one embodiment, a ranked question queue may include information relating to the attendee that posed a particular question or, in the event that multiple attendees posed the same question, information relating to the first attendee that posed the question. If information relating to the attendee is provided, when the question associated with the attendee is to be addressed by a speaker, the attendee may be given the ability to pose his or her question verbally, and then perhaps engage in a substantially real-time verbal discussion with the speaker. In other words, the floor of the conference call, e.g., the ability to become a non-silent attendee, may be given to the originator of a question when the question reaches the top of a ranked questions queue.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

What is claimed is:

1. An apparatus comprising:
an interface, the interface being arranged to obtain a plurality of submissions associated with a conference call, the plurality of submissions comprising at least one text-based submission and at least one audio-based submission; and
a queue generator, the queue generator being arranged to manage a queue, the queue being arranged to comprise representations of the plurality of submissions, the representations comprising a first representation of the at least one text-based submission and a second representation of the at least one audio-based submission, wherein the queue is accessible to a speaker associated with the conference call.

2. The apparatus of claim 1 wherein the representations are textual representations, and the apparatus further comprises a converter, the converter being arranged to convert the at least one audio-based submission into the second representation

3. The apparatus of claim 1 further comprising a prioritizing arrangement, the prioritizing arrangement being capable of creating a prioritized order for the representations, wherein the queue includes the representations in the prioritized order.

4. The apparatus of claim 3 wherein the prioritizing arrangement creates the prioritized order based upon keywords included in the plurality of submissions.

5. The apparatus of claim 3 wherein the prioritizing arrangement comprises a ranking functionality and a filter, the ranking functionality being arranged to determine the prioritized order, the filter being arranged to identify a first submission of the plurality of submissions that is not to have a representation in the queue.

6. The apparatus of claim 1 wherein the plurality of submissions are a plurality of questions, and the interface is further arranged to obtain a plurality of answers that correspond to the plurality of questions from the speaker.

7. The apparatus of claim 5 further comprising a transcript generator, the transcript generator being arranged to generate a transcript that includes the representations of the plurality of questions and representations of the plurality of answers.

8. The apparatus of claim 1 wherein the interface is arranged to obtain the at least one audio-based submission in conjunction with obtaining a floor control request.

9. Logic encoded in one or more tangible media for execution and when executed operable to:
cause a plurality of submissions associated with a conference call to be obtained, wherein the plurality of submissions includes at least one text-based submission and at least one audio-based submission; and
cause a queue to be managed, wherein the queue is accessible to a speaker associated with the conference call and comprises representations of the plurality of submissions, the representations including a first representation of the at least one text-based submission and a second representation of the at least one audio-based submission.

10. The logic of claim 9 wherein the representations are textual representations, the logic further being operable to cause the at least one audio-based submission to be converted into the second representation.

11. The logic of claim 9 further being operable to create a prioritized order for the representations, wherein the logic operable cause the queue to be managed further comprises logic operable to maintain the representations in the prioritized order.

12. A method comprising:
creating a first representation of a first submission associated with a conference call, the first submission having a first format, wherein the first representation has a second format; and
creating a queue, the queue comprising the first representation and a second representation, the queue being accessible to a speaker associated with the conference call, wherein the second representation has the second format and is associated with a second submission having the second format.

13. The method of claim 12 wherein the first format is an audio format and the second format is a text format.

14. The method of claim 13 wherein the conference call is a floor controlled conference call, the method further comprising obtaining the first submission in conjunction with a floor-control request.

15. The method of claim 12 further comprising ranking the first representation and the second representation in an order, wherein creating the queue comprises maintaining the order.

16. The method of claim 15 wherein ranking the first representation and the second representation further comprises ranking a plurality of representations of submissions that includes the first representation and the second representation, the order being determined using keywords appearing in the plurality of representations.

17. The method of claim 15 wherein ranking the first representation and the second representation in the order further comprises:
determining whether a priority criteria is to be used in ranking the first representation and the second representation in the order; and
accounting for the priority criteria in ranking the first representation and the second representation in the order the priority criteria is to be used.

18. The method of claim 15 further comprising determining if the first representation and the second representation represent a question, wherein if the first representation and the second representation represent the question, the first representation and the second representation are grouped together and assigned a common ranking in the order.

19. The method of claim 12 wherein the first submission is a first question, further comprising:
obtaining an answer to the first question; and
creating a transcript, the transcript being arranged to include the first representation and a third representation of the answer.

20. The method of claim 19 wherein the first format is an audio format and the second format is a textual format, the answer being obtained in the first format, the method further comprising creating the third representation, the third representation being of the second format.
